(19) United States
(12) Patent Application Publication
(10) Pub. No.: US 2026/0099484 A1
(43) Pub. Date: Apr. 9, 2026

(54) WORK GRAPH QUEUE STRUCTURES

(71) Applicant: NVIDIA Corporation, Santa Clara, CA (US)

(72) Inventors: Ziyad Hakura, San Jose, CA (US); Kedar Shripad Joglekar, Pune (IN); Hao Zhang, Tokyo (JP); Yury Uralsky, Los Gatos, CA (US)

(21) Appl. No.: 19/188,590

(22) Filed: Apr. 24, 2025

Related U.S. Application Data
(60) Provisional application No. 63/704,874, filed on Oct. 8, 2024.

(51) Int. Cl. G06F 16/23; G06F 16/22

(52) U.S. Cl. CPC G06F 16/2343; G06F 16/2228

(57) ABSTRACT

Disclosed are systems and techniques for efficient work graph queue structures. The techniques include obtaining a first record lock and generating one or more records to be consumed by one or more consumer processes. The techniques further include storing the one or more records in one or more queues including a first index queue associated with a first consumer process of the one or more consumer processes, a counter queue, and a unified record-index queue. At least a first value associated with a first record of the one or more records is stored in the first index queue. The techniques further include, responsive to receiving a first signal from the first consumer process, freeing the first value associated with the first record from the first index queue. The techniques further include releasing the first record lock.

### CROSS-REFERENCE TO RELATED APPLICATIONS

This application claims the benefit of priority to provisional patent application No. 63/704,874, filed Oct. 8, 2024, which is hereby incorporated by reference in its entirety.

### TECHNICAL FIELD

At least one embodiment pertains to queue structures for communicating between nodes of a graph of compute nodes, and more specifically to managing record locks associated with the queue structures.

### BACKGROUND

Parallel processing units, such as graphics processing units, can execute multiple tasks in parallel. In some cases, the tasks to be executed by the parallel processing unit can be expressed as a graph of nodes. Each node can represent a unit of work to be executed on the parallel processing unit. The nodes can have dependencies on other nodes, which can indicate an order of execution and control the flow of data between nodes. Producer nodes can produce data that is used by consumer nodes. In some cases, a node can be both a consumer node (e.g., can use data produced by a previous node in the graph) and a producer node (e.g., can create data that is used by a next node in the graph). In some cases, the data from a producer node can be stored in a queue associated with the consumer node. In some cases, multiple producer nodes can store data in the same queue for a particular consumer node. In some cases, multiple consumer nodes can use data from the same queue.

### BRIEF DESCRIPTION OF THE DRAWINGS

FIG. 1 is a block diagram of an example system for efficient work graph queue structures, according to at least one embodiment.

FIG. 2 is a block diagram of an example work graph of nodes and queues, according to at least one embodiment.

FIG. 3 is an example block diagram of a set of consumer nodes with associated record queues at a particular level of a work graph of nodes, according to at least one embodiment.

FIG. 4 is an example block diagram of a set of consumer nodes with associated index queues that point to a unified record queue at a particular level of a work graph of nodes, according to at least one embodiment.

FIG. 5 is an example block diagram of a set of consumer nodes with associated record-index queues that point to a counter queue at a particular level of a work graph of nodes, according to at least one embodiment.

FIG. 6 is an example block diagram of a set of consumer nodes with associated index queues that point to a unified record-index queue which points to a counter queue at a particular level of a work graph of nodes, according to at least one embodiment.

FIG. 7 is a flow diagram of an example method for efficient work graph queue structures, according to at least one embodiment.

FIG. 8 is a block diagram illustrating an exemplary computer system, in accordance with at least one embodiment of the present disclosure.

FIG. 9A illustrates inference and/or training logic, according to at least one embodiment of the present disclosure.

FIG. 9B illustrates inference and/or training logic, according to at least one embodiment.

FIG. 10 illustrates training and deployment of a neural network, according to at least one embodiment.

FIG. 11 is an example data flow diagram for an advanced computing pipeline, according to at least one embodiment.

FIG. 12 is a system diagram for an example system for training, adapting, instantiating and deploying machine learning models in an advanced computing pipeline, according to at least one embodiment.

### DETAILED DESCRIPTION

A producer node may need to ensure there is space in a consumer node's queue before generating an entry (e.g., “record”) to put in the queue. In some cases, one or more locks (e.g., “reference counts”) can be acquired before the producer node generates an output entry for the consumer node's queue. For example, if the producer node is going to generate 2 output records, before it can generate the output records, it may need to acquire 2 locks (e.g., 2 reference counts).

After an entry has been consumed, the lock corresponding to the entry can be released. A producer node can now acquire that newly released lock and another entry can be added to the queue.

In some cases, there can be multiple producer nodes at the same “level” of the graph of nodes that generate records for one or more consumer nodes that are all on the next “level” of the graph of nodes. The “level” of the graph can be a node depth within the graph. The number of locks available for the producer nodes of a certain level of the graph of nodes may be equal to the number of entries that can be stored in a queue of one of the consumer nodes of the next level of the graph of nodes. Because all the producer nodes of a certain level may put their output records in the same consumer queue, all the consumer queues may need to be sized such that any one can store all of the generated records.

The structure of the record queue(s) can determine how many locks need to be acquired before an entry is created and can determine the amount of memory required for each queue. For example, the amount of memory required for a queue can be based on the number of slots in the queue where entries can be stored and based on the size of each slot/entry. Some queue structures can require large amounts of memory for each queue and may not make efficient use of the number of available locks.

Aspects of the present disclosure address the above and other deficiencies by providing for efficient work graph queue structures. In a first embodiment, each consumer node may have a single queue for storing records. Each queue may have enough slots to store all of the records generated by the producer node. The size of each slot may be equal to expected record size for that particular consumer node. If multiple producer nodes are being executed simultaneously, each consumer node's queue may have enough slots to store all the records generated by all the producer nodes.

When generating records, the producer node(s) may need to acquire one lock for each record that is being created and added to the consumer node queues. In some embodiments, the producer node(s) may acquire locks sufficient to generate a maximum number of records and if the producer node(s) generate fewer records than the maximum, the locks can be immediately released. Once a record of a consumer node's queue has been consumed, it can be marked as “ready to be deallocated.” Once the record is deallocated (e.g., “freed” from the queue), the lock corresponding to the record can be released.

In a second embodiment, there may be a single unified record queue for storing all of the records, and each consumer node may have an index queue that stores a pointer to an entry in the unified record queue. For example, a producer may generate 3 records, each for different consumer nodes. All 3 records may be stored in the unified record queue, and a pointer entry may be added to each consumer node's queue that points to the corresponding entry in the unified record queue.

The number of slots in the unified record queue and in each consumer's index queue may be equal to the maximum number of records that can be generated by the producer node(s) being executed. The size of the slots in the unified record queue may be equal to the maximum output record size of the producer node(s). The size of the slots in each index queue may be sufficient to store a value to identify an entry in the unified record queue. In some embodiments, the value stored in the index queue is a memory address (e.g., a pointer address). In some embodiments, the value stored in the index queue is an index or offset within the unified record queue.

When generating records, the producer node(s) may need to acquire one lock for each record that is being created and stored in the unified record queue. Once a record has been consumed by a consumer node, both the record in the unified record queue and the index queue entry that points to the unified record queue can be marked as “ready to be deallocated.” Because the unified record queue entries and the per-node index queue entries can be added to their respective queues in an arbitrary order, releasing the locks can become problematic.

A lock can be released when the entry in the unified record queue is deallocated, but if the corresponding index queue entry has not been deallocated, there may not be sufficient space for a new index queue entry. In some embodiments, the lock is released only when both the unified record queue entry and the corresponding index queue entry have been deallocated. In some embodiments, the number of slots in each index queue is doubled so that locks can be released when the unified record queue entry is deallocated while still guaranteeing enough space in each index queue for new index queue entries.

In a third embodiment, there may be a single counter queue for storing a count of generated records, and each consumer node may have a record-index queue that stores a generated record and a pointer to an entry in the counter queue. For example, a producer may generate 3 records, each for a different consumer node. A counter entry for the producer node with a value of 3 may be added to the counter queue. Each record may be stored in the corresponding consumer's record-index queue along with a pointer value that identifies the producer's counter entry in the counter queue.

The number of slots in the counter queue may be equal to the number of producer nodes that can run simultaneously. The size of each slot in the counter queue may be sufficient to store a preconfigured maximum counter value. The number of slots in each consumer node's record-index queue may be equal to the maximum number of records the consumer node can receive from each producer multiplied by the maximum number of producer nodes (e.g., producer processes) that can be executed simultaneously. In some embodiments, the number of slots in each consumer node's record-index queue is doubled to avoid the problem discussed with regard to the index queues in the second embodiment. The size of each slot in each consumer node's record-index queue may be sufficient to store a record for the consumer node and a value (e.g., a memory address pointer, an index, an offset, etc.) that identifies the counter queue entry corresponding to the record.

When a record has been consumed, it can be marked as “ready to be deallocated” and the counter entry corresponding to the record can be decremented by one. Once the counter entry's value reaches zero, it can be marked as “ready to be deallocated.” Once the counter entry is deallocated, the lock corresponding to the counter entry can be released.

In a fourth embodiment, there may be a single counter queue for storing a count of generated records, a unified record-index queue for storing all of the records and counter entry indexes, and each consumer node may have an index queue that stores a pointer to an entry in the unified record queue. For example, a producer may generate 3 records, each for a different consumer node. A counter entry for the producer node with a value of 3 may be added to the counter queue. All three records may be added to the record-index queue along with a pointer value that identifies the producer's counter entry in the counter queue. An entry may be added to each consumer node's index queue that points to the corresponding record in the unified record-index queue.

The number of slots in the counter queue may be equal to the number of producer nodes that can run simultaneously. The size of each slot in the counter queue may be sufficient to store a preconfigured maximum counter value.

The number of slots in the unified record-index queue may be equal to the maximum number of records that can be generated by the producer node(s) being executed. In some embodiments, because the unified record-index queue stores index values, the number of slots in the queue may be doubled, as discussed above. The size of each slot in the unified record-index queue may be sufficient to store the maximum record size generated by the producer node(s) and a value (e.g., a memory address pointer, an index, an offset, etc.) that identifies the counter queue entry corresponding to the record.

The number of slots in the per-consumer-node index queues may be equal to the maximum number of records the consumer node can receive from each producer multiplied by the maximum number of producer nodes that can be executed simultaneously. In some embodiments, because the consumer node index queues store index values, the number of slots in the queue may be doubled, as discussed above. The size of each slot in each per-consumer-node index queue may be sufficient to store a value (e.g., a memory address pointer, an index, an offset, etc.) that identifies the corresponding unified record-index queue entry.

When a record has been consumed, both the unified record-index queue entry and the per-consumer-node index queue entry can be marked as “ready to be deallocated,” and the counter entry corresponding to the record can be decremented by one. Once the counter entry's value reaches zero, it can be marked as “ready to be deallocated.” Once the counter entry is deallocated, the lock corresponding to the counter entry can be released.

In any of the above discussed embodiments, more than one consumer node may depend on the data in a particular record. In such a case, the record may store a counter corresponding to the number of consumer nodes that need to access the data. As each consumer node accesses the data of the record, the record's counter value can be decremented. Once the record's counter value reaches zero, indicating that all consumer nodes that need the record's data have used the record's data, the record can be marked as “ready to be deallocated,” as discussed above.

Advantages of the disclosed embodiments over the existing technology include but are not limited to reduced memory storage requirements and more efficient lock management for storing records in queues of a work graph of nodes.

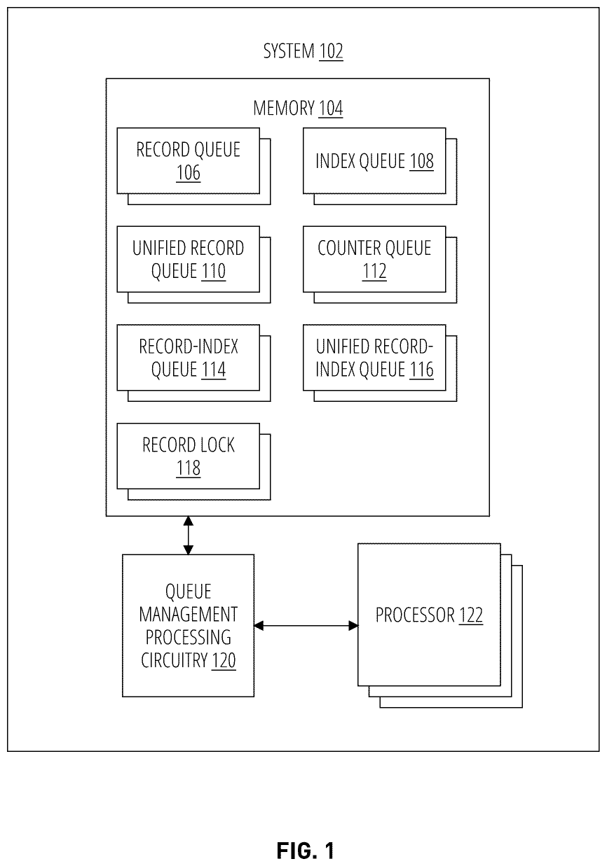

FIG. 1 is a block diagram of an example system 102 for efficient work graph queue structures, according to at least one embodiment. System 102 can include memory 104 and one or more processors 122. Memory 104 can include read-only memory (ROM), flash memory, dynamic random access memory (DRAM), such as synchronous DRAM (SDRAM), double data rate SDRAM (DDR SDRAM), and/or the like. Processors 122 can include one or more processing units, such as central processing units (CPUs), graphics processing units (GPUs), data processing units (DPUs), parallel processing units, accelerators, physics processing units (PPUs), etc. Memory 104 and processors 122 may be connected via queue management processing circuitry 120.

In some embodiments, the operations performed by queue management processing circuitry 120 can be performed by one or more processes executed by a processor, such as one of processors 122. In some embodiments, the operations performed by queue management processing circuitry 120 can be performed by one or more circuit groups.

System 102 can be used to execute work defined in a graph of nodes. Each node can represent a unit of work to be executed by one or more processors 122 of system 102. The nodes can have dependencies on other nodes, which can indicate an order of execution and control the flow of data between nodes. Producer nodes can produce data that is used by consumer nodes. In some cases, the data from a producer node can be stored in a queue associated with the consumer node. The queues associated with each node may be stored in memory 104 by queue management processing circuitry 120. Memory 104 can also include record locks 118, which may be used to ensure sufficient output space is available before generating new records for a queue.

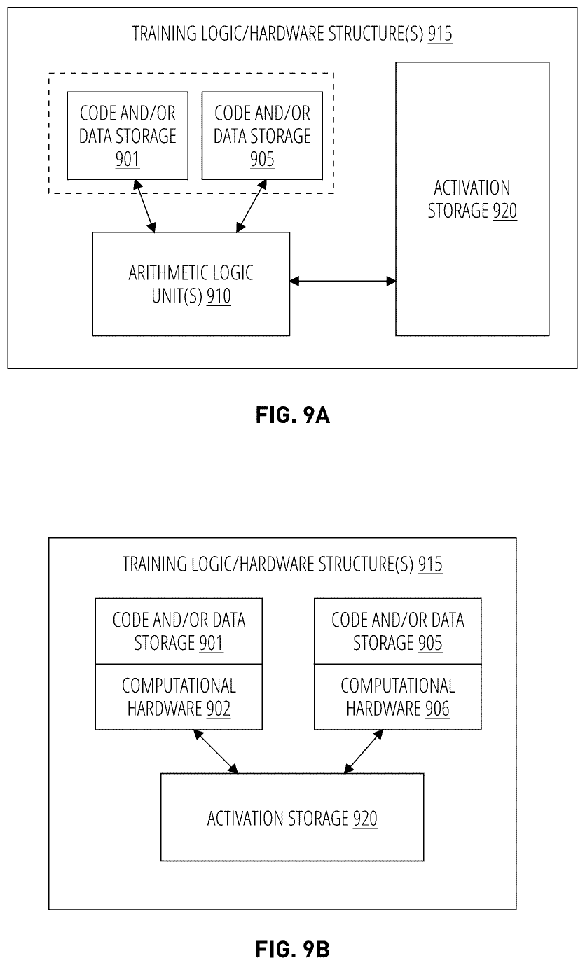

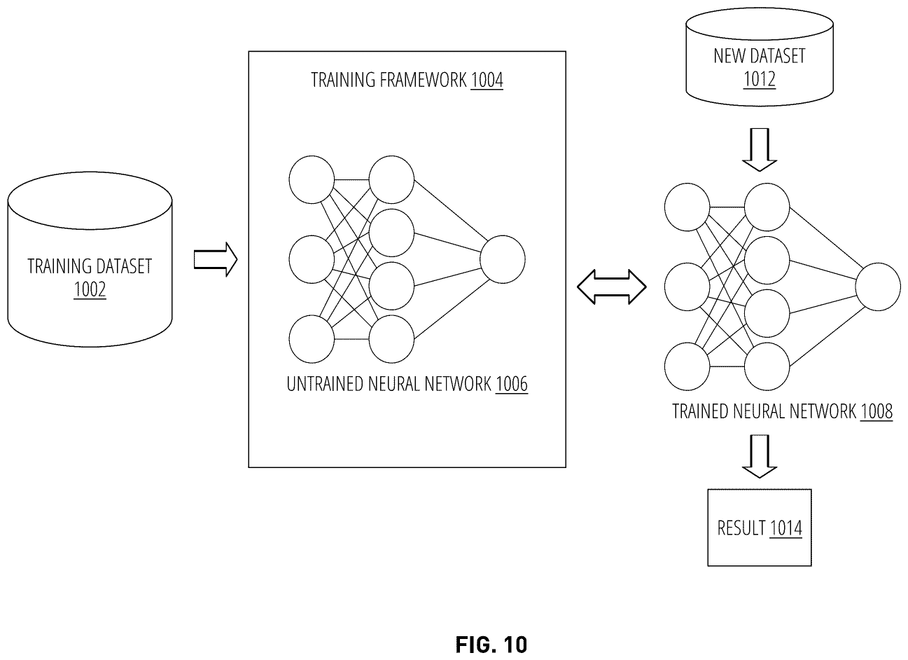

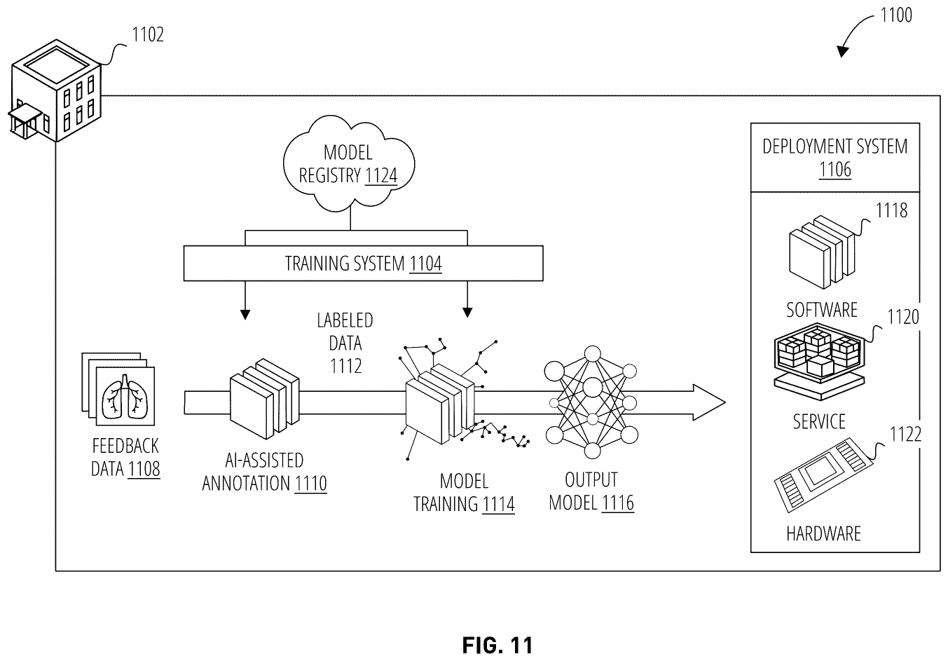

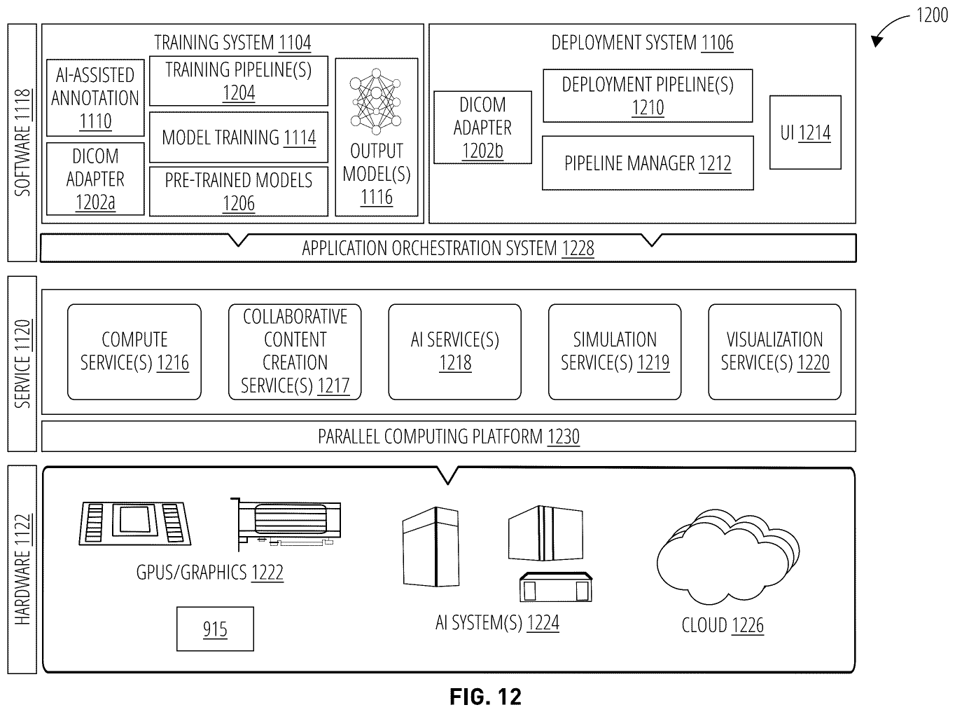

In some embodiments, the work defined in the graph of nodes is graphics rendering work. In some embodiments, the work defined in the graph of nodes is artificial intelligence and/or machine learning work, such as training an artificial intelligence model and/or performing inference on an artificial intelligence model. Training and use of artificial intelligence models may be described in more detail with regard to FIG. 9A, FIG. 9B, FIG. 10, FIG. 11, and FIG. 12.

As an example of a simple work graph, a first node (e.g., a producer node) may be executed by a first processor of processors 122 (or by a first thread of a processor). During execution, the first processor may obtain a record lock (e.g., via queue management processing circuitry 120) for each output record the producer node is going to produce. In some embodiments, if there are not sufficient record locks available, the first processor may idle until sufficient record locks are available. Memory may be allocated for each new record generated by the producer node, and the first processor may cause data to be stored in the new records.

A second node (e.g., a consumer node) may be executed by a second processor of processors 122 (or by a second thread of the first processor). Once all the data has been stored in the queue entry (e.g., once the data is ready to be consumed by a second node), the processor executing the second node may access (e.g., via queue management processing circuitry 120) the data stored in its queue. After the second node is finished using the data stored in the queue entry, the queue entry may be marked as “ready to be deallocated.” Once the record is deallocated (e.g., by queue management processing circuitry 120), the lock that was obtained before writing the entry to the queue can be released.

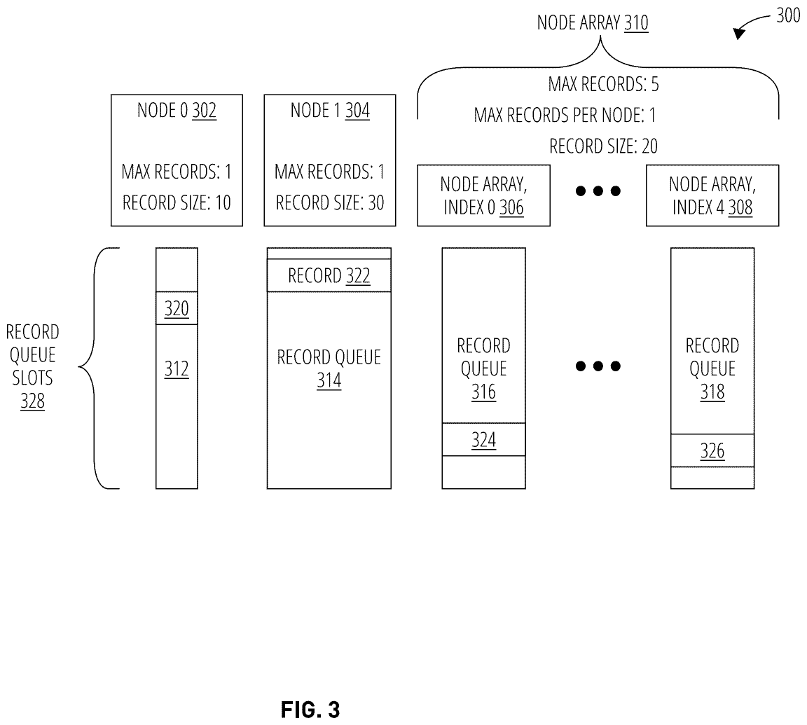

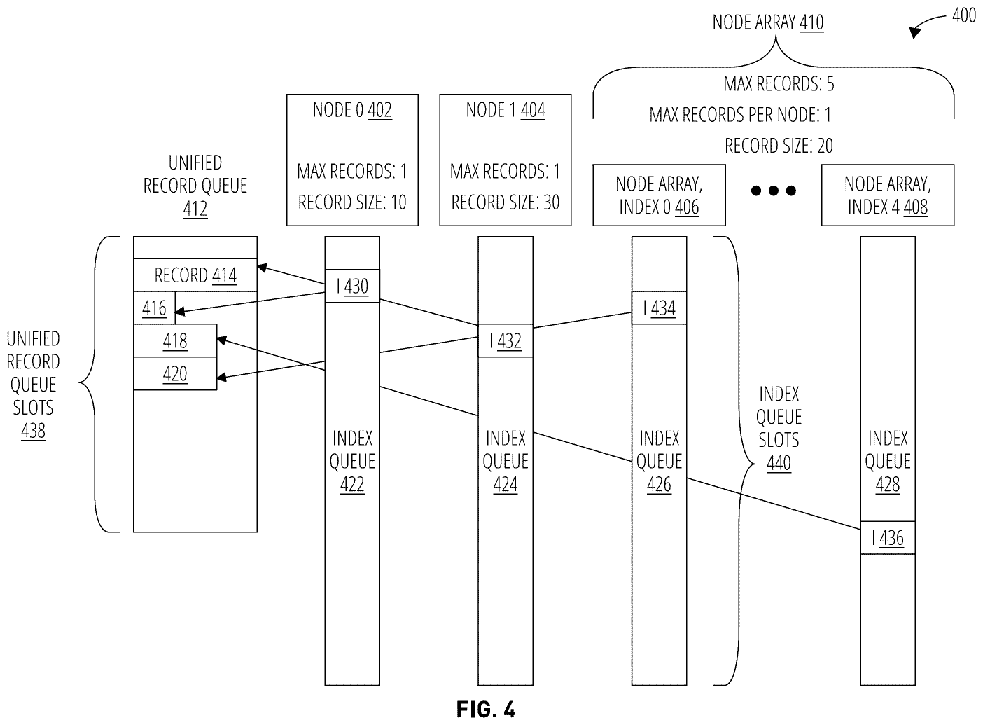

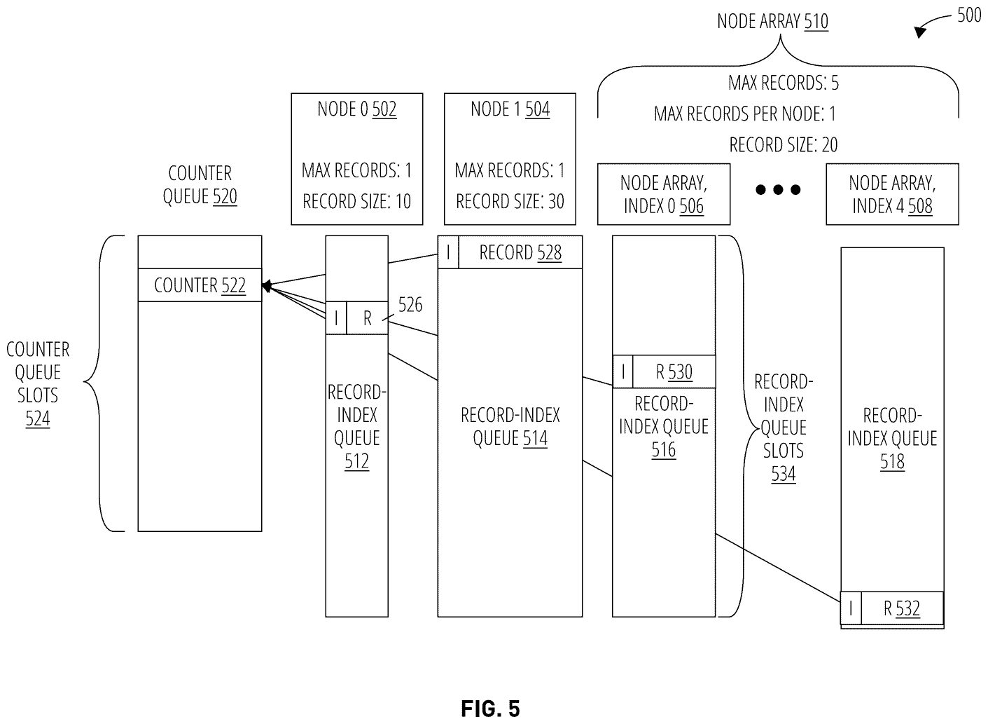

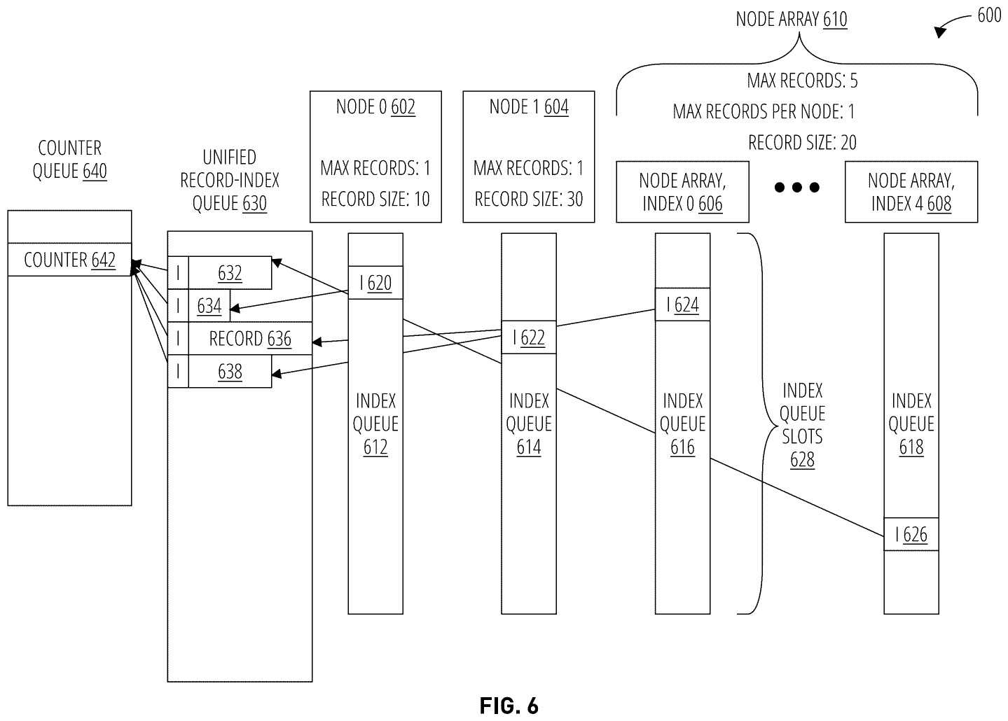

Queue management processing circuitry 120 may manage the one or more queues associated with the nodes of the graph of nodes. In some embodiments, each consumer node has an associated record queue (e.g., record queue 106), as described in FIG. 3. In some embodiments, each consumer node has an associated index queue (e.g., index queue 108) that points to an entry in a unified record queue (e.g., unified record queue 110), as described in FIG. 4. In some embodiments, each consumer node has an associated record-index queue (e.g., record-index queue 114) that points to an entry in a counter queue (e.g., counter queue 112), as described in FIG. 5. In some embodiments, each consumer node has an index queue (e.g., index queue 108) that points to an entry in a unified record-index queue (e.g., unified record-index queue 116) which points to an entry in a counter queue (e.g., counter queue 112), as described in FIG. 6.

The number of slots in each queue and the size of each slot in the queue will be discussed in more detail below.

Although all queues are shown in memory 104, some embodiments may include a subset of the queues shown and may not include all the queues. For example, in an embodiment similar to that depicted in FIG. 3, record queues may be the only queues used. In an embodiment similar to that depicted in FIG. 4, index queues and unified record queues may be used without the other queues, and so forth. In some embodiments, all the queues are used. In some embodiments, a first set of nodes of the graph of nodes may use queues similar to those depicted in FIG. 5 while a second set of nodes of the graph of nodes may use queues similar to those depicted in FIG. 6.

Queue management processing circuitry 120 may also manage the locks (e.g., record locks, reference counts) associated with the queues. In some embodiments, locks may be acquired for each entry that is being added to a consumer queue. In some embodiments, a single lock may be acquired for a particular producer node, regardless of the number of entries that are being produced.

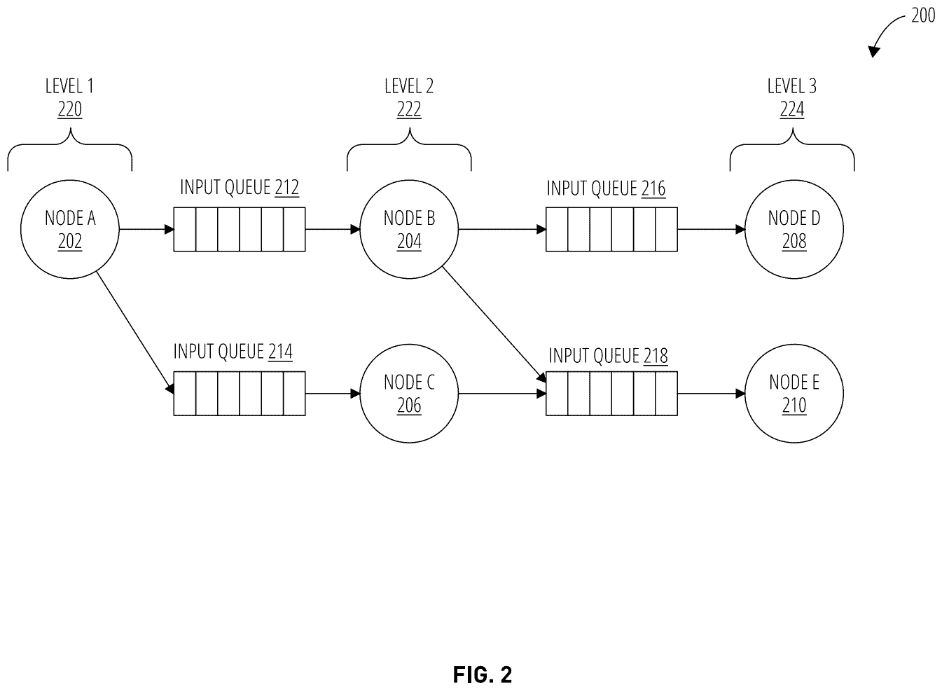

FIG. 2 is a block diagram of an example work graph 200 of nodes and queues, according to at least one embodiment. Work graph 200 may include node A 202, node B 204, node C 206, node D 208, and node E 210. Node A 202 may be a producer node that provides records to be consumed by node B 204 and/or node C 206. For example, node A 202 may generate a first record and store it in input queue 212 to be consumed by node B 204. Node A 202 may also generate a second record and store it in input queue 214 to be consumed by node C 206. Node A 202 may be at a first level (e.g., level 1 220) of the graph of nodes. All of the nodes at level 1 220 may share the same set of locks when generating records to store in input queues (e.g., input queue 212, input queue 214).

Node B 204 and node C 206 may be consumer nodes that use the data stored in the records created by node A 202. For example, node B 204 may read one or more entries from input queue 212. Node C 206 may read one or more entries from input queue 214. As the entries are consumed and deallocated from the queue, the locks node A 202 acquired to write those entries may be released (e.g., by node B 204 or node C 206).

Node B 204 and node C 206 can also be producer nodes that provide records to be consumed by node D 208 and/or node E 210. For example, node B 204 may generate a first record and store it in input queue 216 to be consumed by node D 208. Node B 204 may generate a second record and store it in input queue 218 to be consumed by node E 210. Node C 206 may generate a third record and store it in input queue 218 to be consumed by node E 210.

Node B 204 and node C 206 may be at a second level (e.g., level 2 222) of the graph of nodes. All of the nodes at level 2 222 may share the same set of locks when generating records to store in input queues (e.g., input queue 216, input queue 218). For example, level 2 222 may have 5 locks available. Node B 204 may acquire two locks before generating its output records (e.g., 1 lock for the record to be stored in input queue 216 and 1 lock for the record to be stored in input queue 218). There may be 3 locks remaining after node B 204's acquisition. Node C 206 may acquire one lock before generating its output record (e.g., 1 lock for the record to be stored in input queue 218). There may be 2 locks remaining after node C 206's acquisition.

As another example, if level 2 222 only had 2 locks available, node B 204 may have acquired both locks before generating its records. In such a case, node C 206 may need to wait until at least one of the records generated by node B 204 has been consumed and deallocated so that the corresponding lock is released. Once the lock is released, it may be acquired by node C 206, and then node C 206 can generate its output record.

Node D 208 and node E 210 may be at a third level (e.g., level 3 224) of the graph of nodes and can be consumer nodes that use the data stored in the records created by node B 204 and/or node C 206. For example, node D 208 may read one or more entries from input queue 216. Node E 210 may read one or more entries from input queue 218. As the entries are consumed and deallocated from the queues, the locks node B 204 and/or node C 206 acquired to write those entries may be released (e.g., by node D 208 or node E 210).

FIG. 3 is an example block diagram of a set of consumer nodes 300 with associated record queues at a particular level of a work graph of nodes, according to at least one embodiment. Set of consumer nodes 300 can include node 0 302, node 1 304, and node array 310, which may include 5 nodes (e.g., node array, index 0 306 through node array, index 4 308). Each node may have a configured maximum number of records it can receive from a producer node (e.g., “max records”) and a configured maximum amount of data that can be included in each record (e.g., “record size”). For example, node 0 302 may be able to receive up to 1 record (e.g., “max record”equal to 1) of size 10 (e.g., “record size”equal to 10). Although the examples depicted throughout this description do not include units, it should be understood that the record size can be represented using any suitable unit of memory (e.g., bits, bytes, kilobytes, megabytes, etc.).

Node 1 304 may also be configured to receive up to 1 record, but its record may be up to size 30. The nodes included in node array 310 (e.g., node array, index 0 306 through node array, index 4 308) may share some configurations. For example, node array 310 as a whole may receive up to 5 records (e.g., “max records” equal to 5), with each individual node receiving up to 1 record (e.g., “max records per node” equal to 1). All the records provided to node array 310 may be up to size 20.

Each node of set of consumer nodes 300 may have an associated record queue. For example, record queue 312 may be associated with node 0 302, record queue 314 may be associated with node 1 304, record queue 316 may be associated with node array, index 0 306, and record queue 318 may be associated with node array, index 4 308.

Each record queue can include one or more records generated by a producer node on a level of the work graph of nodes just before the consumer nodes' level. For example, the producer node may have generated record 320 of size 10 and stored it in record queue 312. The producer node may have generated record 322 of size 30 and stored it in record queue 314. The producer node may have generated record 324 of size 20 and stored it in record queue 316 and may have generated record 326 also of size 20 and stored it in record queue 318.

Before the producer node began execution (e.g., before the producer node started producing record 320, record 322, record 324, and record 326), it may have acquired 4 locks, one for each record to be generated. In some embodiments, the producer node may have generated a number of records equal to the maximum that each node can receive. For example, since node 0 302 can receive up to 1 record, node 1 304 can receive up to 1 record, and node array 310 can receive up to 5 records, the producer node may have generated 7 records (e.g., “sum of max records”). The producer record may have acquired 7 locks, generated 4 records, and then immediately released the 3 extra locks that were not used.

Record queue slots 328 may indicate the number of slots in each record queue, which, in some embodiments, may be equal to “sum of max records” (e.g., 7 in this example) across all the consumer nodes at a particular level of the work graph of nodes. Thus, the number of slots in each record queue may be the same for all the consumer nodes of set of consumer nodes 300. In particular, the record queues associated with the nodes of node array 310 may have the same number of slots.

In some embodiments, multiple producers can be executed simultaneously, and the number of slots in each record queue may be adjusted to account for records from those other producers. For example, if N producers are executing simultaneously, record queue slots 328 may be equal to “sum of max records” multiplied by N.

After a particular record is accessed (e.g., “consumed”) by a consumer node, it can be marked as “ready to be deallocated.” Once the record is actually deallocated, the lock that was acquired by the producer node to write the record into the queue may be released (e.g., by the consumer node). In some embodiments, multiple consumer nodes can access a particular record in a queue. In such a case, the record may store a counter (not shown) initialized to the number of consumer nodes that will access the data. As each consumer node accesses the data in the record, the record's counter value can be decremented. Once the counter value reaches zero, the record can be marked as “ready to be deallocated.”

FIG. 4 is an example block diagram of a set of consumer nodes 400 with associated index queues that point to a unified record queue at a particular level of a work graph of nodes, according to at least one embodiment. Set of consumer nodes 400 can include node 0 402, node 1 404, and node array 410, which may include 5 nodes (e.g., node array, index 0 406 through node array, index 4 408). Node 0 402 may be configured to receive up to 1 record of size 10.Node 1 404 may be configured to receive up to 1 record of size 30. Node array 410 as a whole may receive up to 5 records (e.g., “max records” equal to 5). The nodes of node array 410 (e.g., node array, index 0 406 through node array, index 4 408) may all be configured to received up to 1 record (e.g., “max records per node” equal to 1) of size 20.

Each node of set of consumer nodes 400 may have an associated index queue. For example, index queue 422 may be associated with node 0 402, index queue 424 may be associated with node 1 404, index queue 426 may be associated with node array, index 0 406, and index queue 428 may be associated with node array, index 4 408.

Each index queue can include one or more index records that point to records generated by a producer node on a level of the work graph of nodes just before the consumer nodes' level. The generated records may all be stored in unified record queue 412. For example, the producer node may have generated record 414, stored it in unified record queue 412, and stored index 432 pointing to record 414 in index queue 424. Because record 414 is for node 1 404, it may have a size up to 30.

The producer node may also have generated record 416, stored it in unified record queue 412, and stored index 430 pointing to record 416 in index queue 422. Because record 416 is for node 0 402, it may have a size up to 10 and may not fill its slot within unified record queue 412.

The producer node may also have generated record 418, stored it in unified record queue 412, and stored index 436 pointing to record 418 in index queue 428. Because record 418 is for node array, index 4 408, it may have a size up to 20 and may not fill its slot within unified record queue 412.

The producer node may also have generated record 420, stored it in unified record queue 412, and stored index 434 pointing to record 420 in index queue 426. Because record 420 is for node array, index 0 406, it may have a size up to 20 and may not fill its slot within unified record queue 412.

Before the producer node began execution (e.g., before the producer node started producing record 414, record 416, record 418, record 420, etc.), it may have acquired 4 locks, one for each record to be generated. In some embodiments, the producer node may have generated “sum of max records” records (e.g., 7 records), as discussed above. The producer may have acquired “sum of max records” (e.g., 7) locks, generated 4 records, and then immediately released the 3 extra locks that were not used.

Each index in an index queue may include a value that indicates which record in unified record queue 412 should be accessed. In some embodiments, the index value is a memory address pointer. In some embodiments, the index value is an index within unified record queue 412. In some embodiments, the index value is an offset value indicating a position within unified record queue 412.

Unified record queue slots 438 may indicate the number of slots in unified record queue 412, which, in some embodiments, may be equal to “sum of max records” (e.g., 7 in this example). In some embodiments, multiple producers can be executed simultaneously, and the number of slots in unified record queue 412 may be adjusted to account for records from those other producers. For example, if N producers are executing simultaneously, unified record queue slots 438 may be equal to “sum of max records” multiplied by N.

The size of each slot in unified record queue 412 may be equal to the maximum record size of all the nodes in set of consumer nodes 400. For example, the max record size among 10, 30, and 20 is 30, so each slot of unified record queue 412 may be able to store a record of size 30, even if the record ends up being smaller than that.

Index queue slots 440 may indicate the number of slots in each index queue, which, in some embodiments, may also be equal to “sum of max records” (e.g., 7 in this example) across all the consumer nodes at a particular level of the work graph of nodes. Thus, the number of slots in each index queue may be the same for all the consumer nodes of set of consumer nodes 400. In particular, the index queues associated with the nodes of node array 410 may have the same number of slots.

If N producers are executing simultaneously, index queue slots 440 may be equal to “sum of max records” multiplied by N. The size of each slot in each index queue may be sufficient to store the index value that points at a record in unified record queue 412.

A consumer node may access the index value stored in the index queue associated with the consumer node and may use that value to find the corresponding record in unified record queue 412. After a particular record is accessed (e.g., “consumed”) by a consumer node, both the index queue entry and the unified record queue entry can be marked as “ready to be deallocated.”

The lock corresponding to the unified record queue entry can be released with the unified record queue is deallocated, but if the corresponding index queue entry has not been deallocated yet, there may not be sufficient space for a new index queue entry. In some embodiments, the lock is released only when both the unified record queue entry and the corresponding index queue entry have been deallocated. However, this can lead to delays and increased latency. In some embodiments, the number of slots in each index queue can be doubled so that locks can be released when the unified record queue entry is deallocated while still guaranteeing enough space in each index queue for new index queue entries. Thus, in some embodiments, index queue slots 440 may be equal to “sum of max records” multiplied by N multiplied by 2.

As discussed previously, multiple consumer nodes may access a particular record, and the record can track how many consumer nodes still need to access the record. Once all consumer nodes have accessed the record, it can be marked as “ready to be deallocated.”

FIG. 5 is an example block diagram of a set of consumer nodes 500 with associated record-index queues that point to a counter queue at a particular level of a work graph of nodes, according to at least one embodiment. Set of consumer nodes 500 can include node 0 502, node 1 504, and node array 510, which may include 5 nodes (e.g., node array, index 0 506 through node array, index 4 508). Node 0 502 may be configured to receive up to 1 record of size up to 10. Node 1 504 may be configured to receive up to 1 record of size up to 30. The nodes of node array 510 (e.g., node array, index 0 506 through node array, index 4 508) may all be configured to receive up to 1 record each of size up to 20.

When generating records, a producer node may acquire 1 lock for an entry in counter queue 520. The counter queue entry (e.g., counter 522) may have a counter value equal to the number of records generated (or to be generated) by the producer node. All records generated by the producer node may have an index value that points to the counter queue entry.

Each node of set of consumer nodes 500 may have an associated record-index queue. For example, record-index queue 512 may be associated with node 0 502, record-index queue 514 may be associated with node 1 504, record-index queue 516 may be associated with node array, index 0 506, and record-index queue 518 may be associated with node array, index 4 508.

Each record-index queue entry can include a record generated by a producer node on a level of the work graph of nodes just before the consumer nodes' level and an index that points to a counter entry in counter queue 520. For example, the producer may have generated record 526 and stored it in record-index queue 512 with an index pointing to counter 522 in counter queue 520. Because record 526 is for node 0 502, it may have a size up to 10.

The producer node may also have generated record 528 and stored it in record-index queue 514 with an index pointing to counter 522 in counter queue 520. Because record 528 is for node 1 504, it may have a size up to 30.

The producer node may also have generated record 530 and stored it in record-index queue 516 with an index pointing to counter 522 in counter queue 520. Because record 530 is for node array, index 0 506, it may have a size up to 20.

The producer node may also have generated record 532 and stored it in record-index queue 518 with an index pointing to counter 522 in counter queue 520. Because record 532 is for node array, index 4 508, it may have a size up to 20.

The index value in each record-index queue entry may include a value that indicates which counter entry in counter queue 520 should be accessed (e.g., decremented). In some embodiments, the index value is a memory address pointer. In some embodiments, the index value is an index within counter queue 520. In some embodiments, the index value is an offset value indicating a position within counter queue 520.

Before the producer node began execution (e.g., before the producer node started producing record 526, record 528, record 530, record 532, etc.), it may have acquired 1 lock for counter 522 in counter queue 520. Because the producer node generated 4 records, counter 522 may have been initialized with a counter value of 4.

A consumer node may access the record stored in the record-index queue corresponding to the consumer node. After a particular record is accessed (e.g., “consumed”) by the consumer node, the record-index queue entry can be marked as “ready to be deallocated,” and the counter value that is pointed at by the record-index queue can be decremented by one. Once the counter value in a counter queue entry reaches zero (indicating that all records generated by the producer node have been consumed), the counter queue entry can be marked as “ready to be deallocated.” Once the counter queue entry is deallocated, the lock corresponding to the counter queue entry can be released.

Counter queue slots 524 may indicate the number of slots in counter queue 520, which, in some embodiments, may be equal to the number of producer nodes that can execute simultaneously (e.g., “N”). Thus, each producer node may be able to have one entry in counter queue 520 at a time.

The size of each slot in counter queue 520 may be sufficient to store a predetermined maximum counter value that can represent the most records a single producer node can generate at a time. For example, if the maximum number of records a single producer node can generate at a time is 64, the size of each slot in counter queue 520 may be big enough to store a counter value of 64, such as at least 6 bits of data.

Record-index queue slots 534 may indicate the number of slots in each record-index queue, which, in some embodiments, may be equal to the maximum number of records the consumer node corresponding to the record-index queue can receive (e.g., “max records per node”). The “max records per node” value for a node outside of a node array may be equal to the “max records” value for the node. The “max records per node” value for a node inside of a node array may be different than the “max records” value of the node array as a whole. In some embodiments, the “max records per node” value for a node inside of a node array may be different than the “max records per node” values of other nodes inside the same node array.

For example, node 0 502 has a “max records” value (and a “max records per node” value) of 1 and may have 1 slot in its corresponding record-index queue 512. If another node had a “max records” value of 2, it may have twice as many slots in its corresponding record-index queue. Thus, the number of slots in each record-index queue may be different for each consumer node in set of consumer nodes 500. In particular, the record-index queues associated with the nodes of node array 510 may have different numbers of slots.

For example, in some embodiments, a node array can have a “max records” value of 10, and the node array may include 3 nodes. The first node of the node array can have a “max records per node” value of 2 while the second and third nodes of the node array may have a “max records per node” value of 4. The record-index queues associated with the second and third nodes of the node array may have twice as many slots as the record-index queue associated with the first node of the node array.

If N producers are executing simultaneously, record-index queue slots 534 may be equal to the “max records” of the consumer node corresponding to the queue multiplied by N.

In some embodiments, to avoid the increased delays and latency discussed above with other index queues, the number of slots in each record-index queue can be doubled so that locks can be released when the counter queue entry is deallocated while still guaranteeing enough space in each record-index queue for new record-index entries. Thus, in some embodiments, record-index queue slots 534 may be equal to “max records” multiplied by N multiplied by 2.

As discussed previously, multiple consumer nodes may access a particular record, and the record can track how many consumer nodes still need to access the record. Once all consumer nodes have accessed the record, it can be marked as “ready to be deallocated” and the counter the record points to can be decremented.

FIG. 6 is an example block diagram of a set of consumer nodes 600 with associated index queues that point to a unified record-index queue which points to a counter queue at a particular level of a work graph of nodes, according to at least one embodiment. Set of consumer nodes 600 can include node 0 602, node 1 604, and node array 610, which may include 5 nodes (e.g., node array, index 0 606 through node array, index 4 608). Node 0 602 may be configured to receive up to 1 record of size up to 10. Node 1 604 may be configured to receive up to 1 record of size up to 30. The nodes of node array 610 (e.g., node array, index 0 606 through node array, index 4 608) may all be configured to receive up to 1 record each of size up to 20.

When generating records, a producer node may acquire 1 lock for an entry in counter queue 640. The counter queue entry (e.g., counter 642) may have a counter value equal to the number of records generated (or to be generated) by the producer node. All records generated by the producer node may be stored in unified record-index queue 630 and may have an index value that points to the counter queue entry. For each record generated by the producer node, an index queue entry that points to the record in the unified record-index queue may be added to an index queue of a consumer node.

Each node of set of consumer nodes 600 may have an associated index queue. For example, index queue 612 may be associated with node 0 602, index queue 614 may be associated with node 1 604, index queue 616 may be associated with node array, index 0 606, and index queue 618 may be associated with node array, index 4 608.

Each index queue entry can include an index value that points to a record in unified record-index queue 630 generated by a producer node on a level of the work graph of nodes just before the consumer nodes' level. For example, the producer may have generated record 632, stored it in unified record-index queue 630 with an index that points to counter 642, and stored index 626 pointing to record 632 in index queue 618. Because record 632 is intended for node array, index 4 608, it may have a size up to 20 and may not fill its slot in unified record-index queue 630.

The producer node may also have generated record 634, stored it in unified record-index queue 630 with an index that points to counter 642, and stored index 620 pointing to record 634 in index queue 612. Because record 634 is intended for node 0 602, it may have a size up to 10 and may not fill its slot in unified record-index queue 630.

The producer node may also have generated record 636, stored it in unified record-index queue 630 with an index that points to counter 642, and stored index 622 pointing to record 636 in index queue 614. Because record 636 is intended for node 1 604, it may have a size up to 30 and may fill its slot in unified record-index queue 630.

The producer node may also have generated record 638, stored it in unified record-index queue 630 with an index that points to counter 642, and stored index 624 pointing to record 638 in index queue 616. Because record 638 is intended for node array, index 0 606, it may have a size up to 20 and may not fill its slot in unified record-index queue 630.

The index value in each index queue entry may include a value that indicates which unified record-index entry in unified record-index queue 630 should be accessed (e.g., consumed). In some embodiments, the index value is a memory address pointer. In some embodiments, the index value is an index within unified record-index queue 630. In some embodiments, the index value is an offset value indicating a position within unified record-index queue 630.

The index value in each unified record-index queue entry may include a value that indicates which counter queue entry in counter queue 640 should be accessed (e.g., decremented). In some embodiments, the index value is a memory address pointer. In some embodiments, the index value is an index within counter queue 640. In some embodiments, the index value is an offset value indicating a position within counter queue 640.

Before the producer node began executing (e.g., before the producer node started producing record 632, record 634, record 636, record 638, etc.), it may have acquired 1 lock for counter 642 in counter queue 640. Because the producer node generated 4 records, counter 642 may have been initialized with a counter value of 4.

A consumer node may use the index value stored in the index queue to access a record in unified record-index queue 630. After a particular record is accessed (e.g., “consumed”) by the consumer node, the index queue entry can be marked as “ready to be deallocated.” The unified record-index queue entry can also be marked as “ready to be deallocated.” The counter value that is pointed to by the unified record-index queue entry can be decremented by one. Once the counter value in a counter queue entry reaches zero (indicating that all records generated by the producer node have been consumed), the counter queue entry can be marked as “ready to be deallocated.” Once the counter queue entry is deallocated, the lock corresponding to the counter queue entry can be released.

Index queue slots 628 may indicate the number of slots in each index queue, which, in some embodiments, may be equal to the maximum number of records the consumer node corresponding to the record-index queue can receive (e.g., “max records per node”). The “max records per node” value for a node outside of a node array may be equal to the “max records” value for the node. The “max records per node” value for a node inside of a node array may be different than the “max records” value of the node array as a whole. In some embodiments, the “max records per node” value for a node inside of a node array may be different than the “max records per node” values of other nodes inside the same node array.

For example, node 0 602 has a “max records” value (and a “max records per node” value) of 1 and may have 1 slot in its corresponding index queue 612. If another node had a “max records” value of 2, it may have twice as many slots in its corresponding index queue. Thus, the number of slots in each index queue may be different for each consumer node in set of consumer nodes 600. In particular, the index queues associated with the nodes of node array 610 may have different numbers of slots.

For example, in some embodiments, a node array can have a “max records” value of 10, and the node array may include 3 nodes. The first node of the node array can have a “max records per node” value of 2 while the second and third nodes of the node array may have a “max records per node” value of 4. The index queues associated with the second and third nodes of the node array may have twice as many slots as the index queue associated with the first node of the node array.

If N producer nodes are executing simultaneously, index queue slots 628 may be equal to the “max records” of the consumer node corresponding to the queue multiplied by N.

In some embodiments, to avoid the increased delays and latency discussed above with other index queues, the number of slots in each index queue can be doubled so that locks can be released when the counter queue entry is deallocated while still guaranteeing enough space in each index queue for new index queue entries. Thus, in some embodiments, index queue slots 628 may be equal to “max records” multiplied by N multiplied by 2.

The size of each slot in each index queue may be sufficient to store the index value that indicates which entry in unified record-index queue 630 corresponds to the particular consumer node.

The number of slots in unified record-index queue 630 may be equal to the “sum of max records,” discussed previously. If N producer nodes are executing simultaneously, the number of slots in unified record-index queue 630 may be equal to “sum of max records” multiplied by N. In some embodiments, the number of slots in unified record-index queue 630 may be equal to “sum of max records” multiplied by N multiplied by 2 to avoid the increased delays and latency discussed above with other index queues.

The size of each slot in unified record-index queue 630 may be equal to the maximum record size of all the nodes in set of consumer nodes 600 plus an amount of space necessary to represent the index value that points to an entry in counter queue 640. For example, the max record size among 10, 30, and 20 is 30, so each slot of unified record-index queue 630 may be able to store a record of size 30, even if the record ends up being smaller than that, plus an index value.

The number of slots in counter queue 640 may be equal to the number of producer nodes that can execute simultaneously (e.g., “N”). Thus, each producer node may be able to have one entry in counter queue 640 at a time.

The size of each slot in counter queue 640 may be sufficient to store a predetermined maximum counter value that can represent the most records a single producer node can generate at a time. For example, if the maximum number of records a single producer node can generate at a time is 64, the size of each slot in counter queue 640 may be big enough to store a counter value of 64, such as at least 6 bits of data.

As discussed previously, multiple consumer nodes may access a particular record, and the record can track how many consumer nodes still need to access the record. Once all consumer nodes have accessed the record, it can be marked as “ready to be deallocated” and the counter the record points to can be decremented.

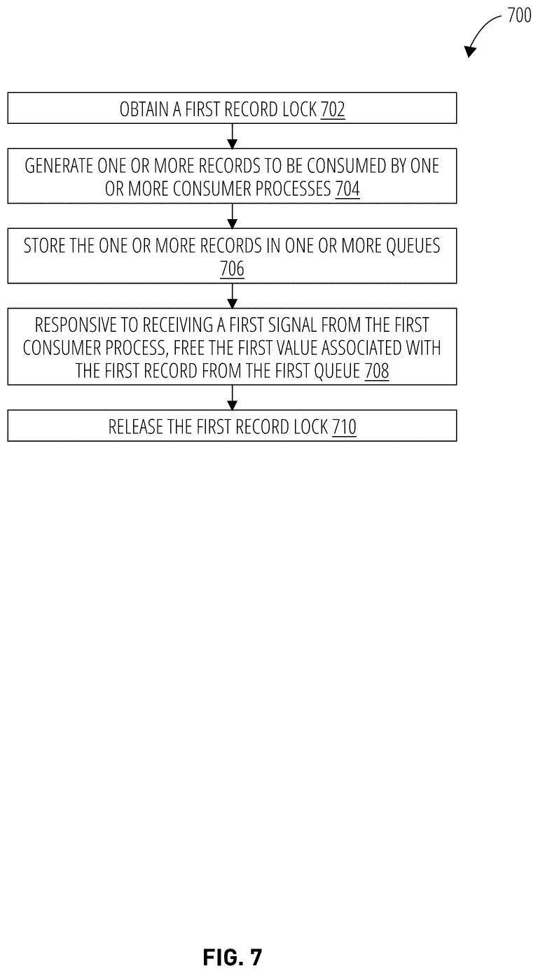

FIG. 7 is a flow diagram of an example method 700 for efficient work graph queue structures, according to at least one embodiment.

Method 700 can be performed using one or more processing units (e.g., CPUs, GPUs, accelerators, physics processing units (PPUs), data processing units (DPUs), etc.), which may include (or communicate with) one or more memory devices. In at least one embodiment, method 700 can be performed using a processing device or processing devices. In at least one embodiment, method 700 can be performed using processing units of system 102 of FIG. 1. In at least one embodiment, method 700 can be performed by queue management processing circuitry 120 of FIG. 1. In at least one embodiment, processing units performing method 700 can be executing instructions stored on a non-transient computer readable storage media. In at least one embodiment, method 700 can be performed using multiple processing threads (e.g., CPU threads and/or GPU threads), individual threads executing one or more individual functions, routines, subroutines, or operations of the method. In at least one embodiment, processing threads implementing method 700 can be synchronized (e.g., using semaphores, critical sections, and/or other thread synchronization mechanisms). Alternatively, processing threads implementing method 700 can be executed asynchronously with respect to each other. Various operations of method 700 can be performed in a different order compared with the order shown in FIG. 7. Some operations of method 700 can be performed concurrently with other operations. In at least one embodiment, one or more operations shown in FIG. 7 may not always be performed.

At block 702, processing units executing method 700 can obtain a first record lock. The first record lock can be a reference count or another value that indicates a number of output record spaces available. At block 704, processing units can generate one or more records to be consumed by one or more consumer processes. In some embodiments, if more than one record is generated, more than one record lock may be obtained.

At block 706, processing units can store the one or more records in one or more queues. A first queue may be associated with a first consumer process. At least a first value associated with a first record of the one or more records may be stored in the first queue. In some embodiments, the first value is data of the first record. In some embodiments, the first value is an index value pointing to an entry in another queue (e.g., a unified record queue, a unified record-index queue) storing the first record. In some embodiments, the first value includes data of the first record and an index value pointing to an entry in a counter queue.

In some embodiments, the one or more queues include the first queue associated with the first consumer process, a counter queue, and a unified record-index queue. The first queue associated with the first consumer process may be a first index queue. Storing the one or more records in the one or more queues may include storing a counter value in the counter queue corresponding to a count of the one or more records, storing the first record in the unified record-index queue, and storing an index of the first record in the first index queue. The index of the first record may be the first value associated with the first record. Storing the one or more records in the one or more queues may further include storing, with the first record in the unified record-index queue, a counter index associated with the counter value in the counter queue.

In some embodiments, processing units can, further responsive to receiving the first signal from the first consumer process, decrement the counter value in the counter queue. In some embodiments, the first record lock corresponds to the counter value in the counter queue and releasing the first lock may be performed responsive to the counter value equaling a lock release value. In some embodiments, the lock release value may be zero.

In some embodiments, the counter value may be incremented instead of decremented. For example, the counter value may be initialized at zero, may be incremented as records are consumed, and may have a lock release value equal to the count of the one or more records.

In some embodiments, a length of the first queue (e.g., the first index queue) may be equal to double a maximum (max) active entries value of the first queue. For example, if a particular consumer node can receive 3 record from a producer node, and there can be N producer nodes active simultaneously, the max active entries value may be equal to 3 multiplied by N. Thus, the length of the first queue may be equal to 3 multiplied by N multiplied by 2.

In some embodiments, a length of the unified record-index queue may be equal to double a max active entries of the unified record-index queue. For example, if a particular producer node may output 7 records, and there can be N producer nodes active simultaneously, the max active entries of the unified record-index queue may be equal to 7 multiplied by N. Thus, the length of the unified record-index queue may be equal to 7 multiplied by N multiplied by 2.

At block 708, processing units can, responsive to receiving a first signal from the first consumer process, free the first value associated with the first record from the first queue. The first signal from the first consumer process may indicate that the first record has been consumed and the first value associated with the first record is ready to be deallocated.

At block 710, processing units can release the first record lock.

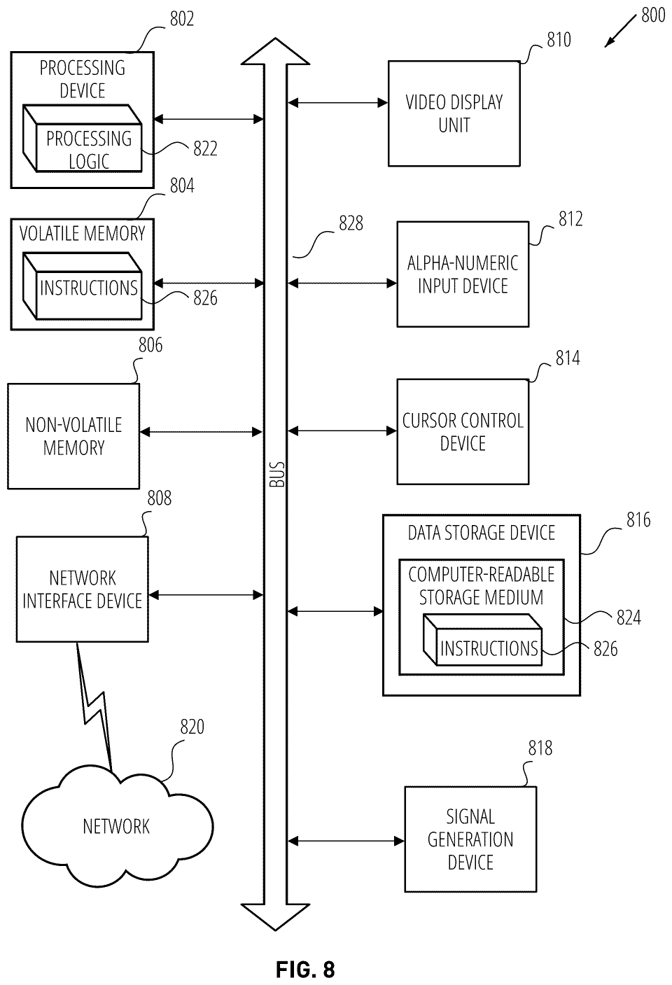

FIG. 8 is a block diagram illustrating an exemplary computer system, in accordance with at least one embodiment of the present disclosure. The computer system 800 can correspond to system 102, described with respect to FIG. 1. Computer system 800 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processing device (processor) 802, a main memory 804 (e.g., read-only memory (ROM), flash memory, dynamic random access memory (DRAM) such as synchronous DRAM (SDRAM), double data rate (DDR SDRAM), or DRAM (RDRAM), etc.), a static memory 806 (e.g., flash memory, static random access memory (SRAM), etc.), and a data storage device 816, which communicate with each other via a bus 828.

Processor (processing device) 802 represents one or more general-purpose processing devices such as a microprocessor, central processing unit, or the like, and may include processing logic 822. More particularly, the processor 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 802 can also be one or more special-purpose processing devices such as an application specific integrated circuit (ASIC), a field programmable gate array (FPGA), a digital signal processor (DSP), network processor, or the like. The processor 802 is configured to execute instructions 826 (e.g., for generating threat indicator alerts) for performing the operations discussed herein.

The computer system 800 can further include a network interface device 808. The computer system 800 also can include a video display unit 810 (e.g., a liquid crystal display (LCD) or a cathode ray tube (CRT)), an input device 812 (e.g., a keyboard, and alphanumeric keyboard, a motion sensing input device, touch screen), a cursor control device 814 (e.g., a mouse), and a signal generation device 818 (e.g., a speaker). In some embodiments, computer system 800 may not include video display unit 810, input device 812, and/or cursor control device 814 (e.g., in a headless configuration).

The data storage device 816 can include a non-transitory machine-readable storage medium 824 (also computer-readable storage medium) on which is stored one or more sets of instructions 826 (e.g., for efficient work graph queue structures) embodying any one or more of the methodologies or functions described herein. The instructions 826 can also reside, completely or at least partially, within the main memory 804 and/or within the processor 802 during execution thereof by the computer system 800, the main memory 804 and the processor 802 also constituting machine-readable storage media. The instructions can further be transmitted or received over a network 820 via the network interface device 808.

In one implementation, the instructions 826 include instructions for efficient work graph queue structures. While the computer-readable storage medium 824 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

### Inference and Training Logic

FIG. 9A illustrates inference and/or training logic 915 used to perform inferencing and/or training operations associated with one or more embodiments.

In at least one embodiment, inference and/or training logic 915 may include, without limitation, code and/or data storage 901 to store forward and/or output weight and/or input/output data, and/or other parameters to configure neurons or layers of a neural network trained and/or used for inferencing in aspects of one or more embodiments. In at least one embodiment, training logic 915 may include (or be coupled to code and/or data storage 901 that stores) graph code or other software to control timing and/or order, in which weight and/or other parameter information is to be loaded to configure processing units, including logic units, integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 901 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 901 may be included with other on-chip or off-chip data storage, including a processor's L1, L2, or L3 cache or system memory.

In at least one embodiment, any portion of code and/or data storage 901 may be internal or external to one or more processors or other hardware logic devices or circuits. In at least one embodiment, code and/or data storage 901 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 901 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 915 may include, without limitation, a code and/or data storage 905 to store backward and/or output weight and/or input/output data corresponding to neurons or layers of a neural network trained and/or used for inferencing in aspects of one or more embodiments. In at least one embodiment, code and/or data storage 905 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 915 may include (or be coupled to code and/or data storage 905 that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 905 may be included with other on-chip or off-chip data storage, including a processor's L1, L2, or L3 cache or system memory. In at least one embodiment, any portion of code and/or data storage 905 may be internal or external to one or more processors or other hardware logic devices or circuits. In at least one embodiment, code and/or data storage 905 may be cache memory, DRAM, SRAM, non-volatile memory (e.g., flash memory), or other storage. In at least one embodiment, a choice of whether code and/or data storage 905 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or code and/or data storage 901 and code and/or data storage 905 may be separate storage structures. In at least one embodiment, code and/or data storage 901 and code and/or data storage 905 may be a combined storage structure. In at least one embodiment, code and/or data storage 901 and code and/or data storage 905 may be partially combined and partially separate. In at least one embodiment, any portion of code and/or data storage 901 and code and/or data storage 905 may be included with other on-chip or off-chip data storage, including a processor's L1, L2, or L3 cache or system memory.

In at least one embodiment, inference and/or training logic 915 may include, without limitation, one or more arithmetic logic unit(s) (“ALU(s)”) 910, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 920 that are functions of input/output and/or weight parameter data stored in code and/or data storage 901 and/or code and/or data storage 905. In at least one embodiment, activations stored in activation storage 920 are generated according to linear algebraic and/or matrix-based mathematics performed by ALU(s) 910 in response to performing instructions or other code, wherein weight values stored in code and/or data storage 905 and/or code and/or data storage 901 are used as operands along with other values, such as bias values, gradient information, momentum values, or other parameters or hyperparameters, any or all of which may be stored in code and/or data storage 905 or code and/or code and/or data storage 901 or another storage on or off-chip.

In at least one embodiment, ALU(s) 910 are included within one or more processors or other hardware logic devices or circuits, whereas in another embodiment, ALU(s) 910 may be external to a processor or other hardware logic device or circuit that uses them (e.g., a co-processor). In at least one embodiment, ALU(s) 910 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or data storage 901, code and/or data storage 905, and activation storage 920 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 920 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 920 may be cache memory, DRAM, SRAM, non-volatile memory (e.g., flash memory), or other storage. In at least one embodiment, activation storage 920 may be completely or partially within or external to one or more processors or other logical circuits. In at least one embodiment, a choice of whether activation storage 920 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 915 illustrated in FIG. 9A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 915 illustrated in FIG. 9A may be used in conjunction with central processing unit (“CPU”) hardware, graphics processing unit (“GPU”) hardware or other hardware, such as field programmable gate arrays (“FPGAs”).

FIG. 9B illustrates inference and/or training logic 915, according to at least one embodiment. In at least one embodiment, inference and/or training logic 915 may include, without limitation, hardware logic in which computational resources are dedicated or otherwise exclusively used in conjunction with weight values or other information corresponding to one or more layers of neurons within a neural network. In at least one embodiment, inference and/or training logic 915 illustrated in FIG. 9B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 915 illustrated in FIG. 9B may be used in conjunction with central processing unit (CPU) hardware, graphics processing unit (GPU) hardware or other hardware, such as field programmable gate arrays (FPGAs). In at least one embodiment, inference and/or training logic 915 includes, without limitation, code and/or data storage 901 and code and/or data storage 905, which may be used to store code (e.g., graph code), weight values and/or other information, including bias values, gradient information, momentum values, and/or other parameter or hyperparameter information. In at least one embodiment illustrated in FIG. 9B, each of code and/or data storage 901 and code and/or data storage 905 is associated with a dedicated computational resource, such as computational hardware 902 and computational hardware 906, respectively. In at least one embodiment, each of computational hardware 902 and computational hardware 906 comprises one or more ALUs that perform mathematical functions, such as linear algebraic functions, only on information stored in code and/or data storage 901 and code and/or data storage 905, respectively, the result of which is stored in activation storage 920.

In at least one embodiment, each of code and/or data storage 901 and 905 and corresponding computational hardware 902 and 906, respectively, correspond to different layers of a neural network, such that resulting activation from one storage/computational pair 901/902 of code and/or data storage 901 and computational hardware 902 is provided as an input to a next storage/computational pair 905/906 of code and/or data storage 905 and computational hardware 906, in order to mirror a conceptual organization of a neural network. In at least one embodiment, each of storage/computational pairs 901/902 and 905/906 may correspond to more than one neural network layer. In at least one embodiment, additional storage/computation pairs (not shown) subsequent to or in parallel with storage/computation pairs 901/902 and 905/906 may be included in inference and/or training logic 915.

### Neural Network Training and Deployment

FIG. 10 illustrates training and deployment of a deep neural network, according to at least one embodiment. In at least one embodiment, untrained neural network 1006 is trained using a training dataset 1002. In at least one embodiment, training framework 1004 is a PyTorch framework, whereas in other embodiments, training framework 1004 is a TensorFlow, Boost, Caffe, Microsoft Cognitive Toolkit/CNTK, MXNet, Chainer, Keras, Deeplearning4j, or other training framework. In at least one embodiment, training framework 1004 trains an untrained neural network 1006 and enables it to be trained using processing resources described herein to generate a trained neural network 1008. In at least one embodiment, weights may be chosen randomly or by pre-training using a deep belief network. In at least one embodiment, training may be performed in either a supervised, partially supervised, or unsupervised manner.

In at least one embodiment, untrained neural network 1006 is trained using supervised learning, wherein training dataset 1002 includes an input paired with a desired output for an input, or where training dataset 1002 includes input having a known output and an output of neural network 1006 is manually graded. In at least one embodiment, untrained neural network 1006 is trained in a supervised manner and processes inputs from training dataset 1002 and compares resulting outputs against a set of expected or desired outputs. In at least one embodiment, errors are then propagated back through untrained neural network 1006. In at least one embodiment, training framework 1004 adjusts weights that control untrained neural network 1006. In at least one embodiment, training framework 1004 includes tools to monitor how well untrained neural network 1006 is converging towards a model, such as trained neural network 1008, suitable to generating correct answers, such as in result 1014, based on input data such as a new dataset 1012. In at least one embodiment, training framework 1004 trains untrained neural network 1006 repeatedly while adjusting weights to refine an output of untrained neural network 1006 using a loss function and adjustment algorithm, such as stochastic gradient descent. In at least one embodiment, training framework 1004 trains untrained neural network 1006 until untrained neural network 1006 achieves a desired accuracy. In at least one embodiment, trained neural network 1008 can then be deployed to implement any number of machine learning operations.

In at least one embodiment, untrained neural network 1006 is trained using unsupervised learning, wherein untrained neural network 1006 attempts to train itself using unlabeled data. In at least one embodiment, unsupervised learning training dataset 1002 will include input data without any associated output data or “ground truth” data. In at least one embodiment, untrained neural network 1006 can learn groupings within training dataset 1002 and can determine how individual inputs are related to untrained dataset 1002. In at least one embodiment, unsupervised training can be used to generate a self-organizing map in trained neural network 1008 capable of performing operations useful in reducing dimensionality of new dataset 1012. In at least one embodiment, unsupervised training can also be used to perform anomaly detection, which allows identification of data points in new dataset 1012 that deviate from normal patterns of new dataset 1012.

In at least one embodiment, semi-supervised learning may be used, which is a technique in which training dataset 1002 includes a mix of labeled and unlabeled data. In at least one embodiment, training framework 1004 may be used to perform incremental learning, such as through transferred learning techniques. In at least one embodiment, incremental learning enables trained neural network 1008 to adapt to new dataset 1012 without forgetting knowledge instilled within trained neural network 1008 during initial training.

With reference to FIG. 11, FIG. 11 is an example data flow diagram for a process 1100 of generating and deploying a processing and inferencing pipeline, according to at least one embodiment. In at least one embodiment, process 1100 may be deployed to perform game name recognition analysis and inferencing on user feedback data at one or more facilities 1102, such as a data center.

In at least one embodiment, process 1100 may be executed within a training system 1104 and/or a deployment system 1106. In at least one embodiment, training system 1104 may be used to perform training, deployment, and embodiment of machine learning models (e.g., neural networks, object detection algorithms, computer vision algorithms, etc.) for use in deployment system 1106. In at least one embodiment, deployment system 1106 may be configured to offload processing and compute resources among a distributed computing environment to reduce infrastructure requirements at facility 1102. In at least one embodiment, deployment system 1106 may provide a streamlined platform for selecting, customizing, and implementing virtual instruments for use with computing devices at facility 1102. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 1106 during execution of applications.

In at least one embodiment, some applications used in advanced processing and inferencing pipelines may use machine learning models or other AI to perform one or more processing steps. In at least one embodiment, machine learning models may be trained at facility 1102 using feedback data 1108 (such as imaging data) stored at facility 1102 or feedback data 1108 from another facility or facilities, or a combination thereof. In at least one embodiment, training system 1104 may be used to provide applications, services, and/or other resources for generating working, deployable machine learning models for deployment system 1106.

In at least one embodiment, a model registry 1124 may be backed by object storage that may support versioning and object metadata. In at least one embodiment, object storage may be accessible through, for example, a cloud storage (e.g., a cloud 1226 of FIG. 12) compatible application programming interface (API) from within a cloud platform. In at least one embodiment, machine learning models within model registry 1124 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline(s) 1204 (FIG. 12) may include a scenario where facility 1102 is training their own machine learning model or has an existing machine learning model that needs to be optimized or updated. In at least one embodiment, feedback data 1108 may be received from various channels, such as forums, web forms, or the like. In at least one embodiment, once feedback data 1108 is received, AI-assisted annotation 1110 may be used to aid in generating annotations corresponding to feedback data 1108 to be used as ground truth data for a machine learning model. In at least one embodiment, AI-assisted annotation 1110 may include one or more machine learning models (e.g., convolutional neural networks (CNNs)) that may be trained to generate annotations corresponding to certain types of feedback data 1108 (e.g., from certain devices) and/or certain types of anomalies in feedback data 1108. In at least one embodiment, AI-assisted annotations 1110 may then be used directly, or may be adjusted or fine-tuned using an annotation tool, to generate ground truth data. In at least one embodiment, in some examples, labeled data 1112 may be used as ground truth data for training a machine learning model. In at least one embodiment, AI-assisted annotations 1110, labeled data 1112, or a combination thereof may be used as ground truth data for training a machine learning model, e.g., via model training 1114 in FIG. 11 and/or FIG. 12. In at least one embodiment, a trained machine learning model may be referred to as an output model 1116, and may be used by deployment system 1106, as described herein.

In at least one embodiment, training pipeline(s) 1204 (FIG. 12) may include a scenario where facility 1102 needs a machine learning model for use in performing one or more processing tasks for one or more applications in deployment system 1106, but facility 1102 may not currently have such a machine learning model (or may not have a model that is optimized, efficient, or effective for such purposes). In at least one embodiment, an existing machine learning model may be selected from model registry 1124. In at least one embodiment, model registry 1124 may include machine learning models trained to perform a variety of different inference tasks on imaging data. In at least one embodiment, machine learning models in model registry 1124 may have been trained on imaging data from different facilities than facility 1102 (e.g., facilities that are remotely located). In at least one embodiment, machine learning models may have been trained on imaging data from one location, two locations, or any number of locations. In at least one embodiment, when being trained on imaging data, which may be a form of feedback data 1108, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 1124. In at least one embodiment, a machine learning model may then be retrained, or updated, at any number of other facilities, and a retrained or updated model may be made available in model registry 1124. In at least one embodiment, a machine learning model may then be selected from model registry 1124—and referred to as output model(s) 1116—and may be used in deployment system 1106 to perform one or more processing tasks for one or more applications of a deployment system.

In at least one embodiment, training pipeline(s) 1204 (FIG. 12) may be used in a scenario that includes facility 1102 requiring a machine learning model for use in performing one or more processing tasks for one or more applications in deployment system 1106, but facility 1102 may not currently have such a machine learning model (or may not have a model that is optimized, efficient, or effective for such purposes). In at least one embodiment, a machine learning model selected from model registry 1124 might not be fine-tuned or optimized for feedback data 1108 generated at facility 1102 because of differences in populations, genetic variations, robustness of training data used to train a machine learning model, diversity in anomalies of training data, and/or other issues with training data. In at least one embodiment, AI-assisted annotation 1110 may be used to aid in generating annotations corresponding to feedback data 1108 to be used as ground truth data for retraining or updating a machine learning model. In at least one embodiment, labeled data 1112 may be used as ground truth data for training a machine learning model. In at least one embodiment, retraining or updating a machine learning model may be referred to as model training 1114. In at least one embodiment, model training 1114 may include data—e.g., AI-assisted annotations 1110, labeled data 1112, or a combination thereof—that may be used as ground truth data for retraining or updating a machine learning model.

In at least one embodiment, deployment system 1106 may include software 1118, service 1120, hardware 1122, and/or other components, features, and functionality. In at least one embodiment, deployment system 1106 may include a software “stack,” such that software 1118 may be built on top of service 1120 and may use service 1120 to perform some or all of processing tasks, and service 1120 and software 1118 may be built on top of hardware 1122 and use hardware 1122 to execute processing, storage, and/or other compute tasks of deployment system 1106.

In at least one embodiment, software 1118 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 1108 (or other data types, such as those described herein). In at least one embodiment, an advanced processing and inferencing pipeline may be defined based on selections of different containers that are desired or required for processing feedback data 1108, in addition to containers that receive and configure imaging data for use by each container and/or for use by facility 1102 after processing through a pipeline (e.g., to convert outputs back to a usable data type for storage and display at facility 1102). In at least one embodiment, a combination of containers within software 1118 (e.g., that make up a pipeline) may be referred to as a virtual instrument (as described in more detail herein), and a virtual instrument may leverage service 1120 and hardware 1122 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1116 of training system 1104.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1124 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1120 as a system (e.g., system 1200 of FIG. 12). In at least one embodiment, once validated by system 1200 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1200 of FIG. 12). In at least one embodiment, completed and validated applications or containers may be stored in a container registry and associated machine learning models may be stored in model registry 1124. In at least one embodiment, a requesting entity that provides an inference or image processing request may browse a container registry and/or model registry 1124 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 1106 (e.g., a cloud) to perform processing of a data processing pipeline. In at least one embodiment, processing by deployment system 1106 may include referencing selected elements (e.g., applications, containers, models, etc.) from a container registry and/or model registry 1124. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, service 1120 may be leveraged. In at least one embodiment, service 1120 may include compute services, collaborative content creation services, simulation services, artificial intelligence (AI) services, visualization services, and/or other service types. In at least one embodiment, service 1120 may provide functionality that is common to one or more applications in software 1118, so functionality may be abstracted to a service that may be called upon or leveraged by applications. In at least one embodiment, functionality provided by service 1120 may run dynamically and more efficiently, while also scaling well by allowing applications to process data in parallel, e.g., using a parallel computing platform 1230 (FIG. 12). In at least one embodiment, rather than each application that shares a same functionality offered by a service 1120 being required to have a respective instance of service 1120, service 1120 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 1120 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software 1118 implementing advanced processing and inferencing pipeline may be streamlined because each application may call upon the same inference service to perform one or more inferencing tasks.

In at least one embodiment, hardware 1122 may include GPUs, CPUs, data processing units (DPUs), an AI/deep learning system (e.g., an AI supercomputer, such as NVIDIA's DGX™ supercomputer system), a cloud platform, or a combination thereof. In at least one embodiment, different types of hardware 1122 may be used to provide efficient, purpose-built support for software 1118 and service 1120 in deployment system 1106. In at least one embodiment, use of GPU processing may be implemented for processing locally (e.g., at facility 1102), within an AI/deep learning system, in a cloud system, and/or in other processing components of deployment system 1106 to improve efficiency, accuracy, and efficacy of game name recognition.

In at least one embodiment, software 1118 and/or service 1120 may be optimized for GPU processing with respect to deep learning, machine learning, and/or high-performance computing, simulation, and visual computing, as non-limiting examples. In at least one embodiment, at least some of the computing environment of deployment system 1106 and/or training system 1104 may be executed in a datacenter or one or more supercomputers or high performance computing systems, with GPU-optimized software (e.g., hardware and software combination of NVIDIA's DGX™ system). In at least one embodiment, hardware 1122 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 12 is a system diagram for an example system 1200 for generating and deploying a deployment pipeline, according to at least one embodiment. In at least one embodiment, system 1200 may be used to implement process 1100 of FIG. 11 and/or other processes including advanced processing and inferencing pipelines. In at least one embodiment, system 1200 may include training system 1104 and deployment system 1106. In at least one embodiment, training system 1104 and deployment system 1106 may be implemented using software 1118, services 1120, and/or hardware 1122, as described herein.

In at least one embodiment, system 1200 (e.g., training system 1104 and/or deployment system 1106) may implemented in a cloud computing environment (e.g., using cloud 1226). In at least one embodiment, system 1200 may be implemented locally with respect to a facility, or as a combination of both cloud and local computing resources. In at least one embodiment, access to APIs in cloud 1226 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1200, may be restricted to a set of public internet service providers (ISPs) that have been vetted or authorized for interaction.

In at least one embodiment, various components of system 1200 may communicate between and among one another using any of a variety of different network types, including but not limited to local area networks (LANs) and/or wide area networks (WANs) via wired and/or wireless communication protocols. In at least one embodiment, communication between facilities and components of system 1200 (e.g., for transmitting inference requests, for receiving results of inference requests, etc.) may be communicated over a data bus or data busses, wireless data protocols (e.g., Wi-Fi), wired data protocols (e.g., Ethernet), etc.

In at least one embodiment, training system 1104 may execute training pipelines 1204, similar to those described herein with respect to FIG. 11. In at least one embodiment, where one or more machine learning models are to be used in deployment pipeline(s) 1210 by deployment system 1106, training pipeline(s) 1204 may be used to train or retrain one or more (e.g., pre-trained) models, and/or implement one or more of pre-trained models 1206 (e.g., without a need for retraining or updating). In at least one embodiment, as a result of training pipeline(s) 1204, output model(s) 1116 may be generated. In at least one embodiment, training pipeline(s) 1204 may include any number of processing steps, AI-assisted annotation 1110, labeling or annotating of feedback data 1108 to generate labeled data 1112, model selection from a model registry, model training 1114, training, retraining, or updating models, and/or other processing steps. In at least one embodiment, DICOM adapter 1202a can be used to access DICOM data. In at least one embodiment, for different machine learning models used by deployment system 1106, different training pipeline(s) 1204 may be used. In at least one embodiment, training pipeline(s) 1204, similar to a first example described with respect to FIG. 11, may be used for a first machine learning model, training pipeline(s) 1204, similar to a second example described with respect to FIG. 11, may be used for a second machine learning model, and training pipeline(s) 1204, similar to a third example described with respect to FIG. 11, may be used for a third machine learning model. In at least one embodiment, any combination of tasks within training system 1104 may be used depending on what is required for each respective machine learning model. In at least one embodiment, one or more of machine learning models may already be trained and ready for deployment so machine learning models may not undergo any processing by training system 1104 and may be implemented by deployment system 1106.

In at least one embodiment, output model(s) 1116 and/or pre-trained models 1206 may include any types of machine learning models depending on embodiment. In at least one embodiment, and without limitation, machine learning models used by system 1200 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipeline(s) 1204 may include AI-assisted annotation. In at least one embodiment, labeled data 1112 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 1108 (or other data type used by machine learning models), there may be corresponding ground truth data generated by training system 1104. In at least one embodiment, AI-assisted annotation may be performed as part of deployment pipeline(s) 1210; either in addition to, or in lieu of, AI-assisted annotation included in training pipeline(s) 1204. In at least one embodiment, system 1200 may include a multi-layer platform that may include a software layer (e.g., software 1118) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 1102. In at least one embodiment, applications may then call or execute one or more services 1120 for performing compute, AI, or visualization tasks associated with respective applications, and software 1118 and/or services 1120 may leverage hardware 1122 to perform processing tasks in an effective and efficient manner.

In at least one embodiment, deployment system 1106 may execute deployment pipelines 1210. In at least one embodiment, deployment pipeline(s) 1210 may include any number of applications that may be sequentially, non-sequentially, or otherwise applied to feedback data (and/or other data types), including AI-assisted annotation, as described above. In at least one embodiment, as described herein, a deployment pipeline(s) 1210 for an individual device may be referred to as a virtual instrument for a device. In at least one embodiment, for a single device, there may be more than one deployment pipeline(s) 1210 depending on information desired from data generated by a device.

In at least one embodiment, applications available for deployment pipeline(s) 1210 may include any application that may be used for performing processing tasks on feedback data or other data from devices. In at least one embodiment, because various applications may share common image operations, in some embodiments, a data augmentation library (e.g., as one of services 1120) may be used to accelerate these operations. In at least one embodiment, to avoid bottlenecks of conventional processing approaches that rely on CPU processing, parallel computing platform 1230 may be used for GPU acceleration of these processing tasks.

In at least one embodiment, deployment system 1106 may include a user interface (UI) 1214 (e.g., a graphical user interface, a web interface, etc.) that may be used to select applications for inclusion in deployment pipeline(s) 1210, arrange applications, modify or change applications or parameters or constructs thereof, use and interact with deployment pipeline(s) 1210 during set-up and/or deployment, and/or to otherwise interact with deployment system 1106. In at least one embodiment, although not illustrated with respect to training system 1104, UI 1214 (or a different user interface) may be used for selecting models for use in deployment system 1106, for selecting models for training, or retraining, in training system 1104, and/or for otherwise interacting with training system 1104.

In at least one embodiment, pipeline manager 1212 may be used, in addition to an application orchestration system 1228, to manage interaction between applications or containers of deployment pipeline(s) 1210 and services 1120 and/or hardware 1122. In at least one embodiment, pipeline manager 1212 may be configured to facilitate interactions from application to application, from application to service 1120, and/or from application or service to hardware 1122. In at least one embodiment, although illustrated as included in software 1118, this is not intended to be limiting, and in some examples pipeline manager 1212 may be included in services 1120. In at least one embodiment, application orchestration system 1228 (e.g., Kubernetes, DOCKER, etc.) may include a container orchestration system that may group applications into containers as logical units for coordination, management, scaling, and deployment. In at least one embodiment, by associating applications from deployment pipeline(s) 1210 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1212 and application orchestration system 1228. In at least one embodiment, so long as an expected input and/or output of each container or application is known by a system (e.g., based on constructs of applications or containers), application orchestration system 1228 and/or pipeline manager 1212 may facilitate communication among and between, and sharing of resources among and between, each of the applications or containers. In at least one embodiment, because one or more of applications or containers in deployment pipeline(s) 1210 may share the same services and resources, application orchestration system 1228 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1228) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1120 leveraged and shared by applications or containers in deployment system 1106 may include compute service(s) 1216, collaborative content creation service(s) 1217, AI service(s) 1218, simulation service(s) 1219, visualization service(s) 1220, and/or other service types. In at least one embodiment, applications may call (e.g., execute) one or more of services 1120 to perform processing operations for an application. In at least one embodiment, compute service(s) 1216 may be leveraged by applications to perform super-computing or other high-performance computing (HPC) tasks. In at least one embodiment, compute service(s) 1216 may be leveraged to perform parallel processing (e.g., using a parallel computing platform 1230) for processing data through one or more of applications and/or one or more tasks of a single application, substantially simultaneously. In at least one embodiment, parallel computing platform 1230 (e.g., NVIDIA's CUDA®) may enable general purpose computing on GPUs (GPGPU) (e.g., GPUs/graphics 1222). In at least one embodiment, a software layer of parallel computing platform 1230 may provide access to virtual instruction sets and parallel computational elements of GPUs, for execution of compute kernels. In at least one embodiment, parallel computing platform 1230 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 1230 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1218 may be leveraged to perform inferencing services for executing machine learning model(s) associated with applications (e.g., tasked with performing one or more processing tasks of an application). In at least one embodiment, AI service(s) 1218 may leverage AI system(s) 1224 to execute machine learning model(s) (e.g., neural networks, such as CNNs) for segmentation, reconstruction, object detection, feature detection, classification, and/or other inferencing tasks. In at least one embodiment, applications of deployment pipeline(s) 1210 may use one or more of output model(s) 1116 from training system 1104 and/or other models of applications to perform inference on imaging data (e.g., DICOM data, RIS data, CIS data, REST compliant data, RPC data, raw data, etc.). For example, DICOM adapter 1202b may be used to access DICOM data. In at least one embodiment, two or more examples of inferencing using application orchestration system 1228 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1228 may distribute resources (e.g., services 1120 and/or hardware 1122) based on priority paths for different inferencing tasks of AI service(s) 1218.

In at least one embodiment, shared storage may be mounted to AI service(s) 1218 within system 1200. In at least one embodiment, shared storage may operate as a cache (or other storage device type) and may be used to process inference requests from applications. In at least one embodiment, when an inference request is submitted, a request may be received by a set of API instances of deployment system 1106, and one or more instances may be selected (e.g., for best fit, for load balancing, etc.) to process a request. In at least one embodiment, to process a request, a request may be entered into a database, a machine learning model may be located from model registry 1124 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 1212) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 1120 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1226, and an inference service may perform inferencing on a GPU.

In at least one embodiment, visualization service(s) 1220 may be leveraged to generate visualizations for viewing outputs of applications and/or deployment pipeline(s) 1210. In at least one embodiment, GPUs/graphics 1222 may be leveraged by visualization service(s) 1220 to generate visualizations. In at least one embodiment, rendering effects, such as ray-tracing or other light transport simulation techniques, may be implemented by visualization service(s) 1220 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1220 may include an internal visualizer, cinematics, and/or other rendering or image processing capabilities or functionality (e.g., ray tracing, rasterization, internal optics, etc.).

In at least one embodiment, hardware 1122 may include GPUs/graphics 1222, AI system(s) 1224, cloud 1226, and/or any other hardware used for executing training system 1104 and/or deployment system 1106. In at least one embodiment, GPUs/graphics 1222 (e.g., NVIDIA's TESLA® and/or QUADRO® GPUs) may include any number of GPUs that may be used for executing processing tasks of compute service(s) 1216, collaborative content creation service(s) 1217, AI service(s) 1218, simulation service(s) 1219, visualization service(s) 1220, other services, and/or any of features or functionality of software 1118. For example, with respect to AI service(s) 1218, GPUs/graphics 1222 may be used to perform pre-processing on imaging data (or other data types used by machine learning models), post-processing on outputs of machine learning models, and/or to perform inferencing (e.g., to execute machine learning models). In at least one embodiment, cloud 1226, AI system(s) 1224, and/or other components of system 1200 may use GPUs/graphics 1222. In at least one embodiment, cloud 1226 may include a GPU-optimized platform for deep learning tasks. In at least one embodiment, AI system(s) 1224 may use GPUs, and cloud 1226—or at least a portion tasked with deep learning or inferencing—may be executed using one or more AI system(s)s 1224. As such, although hardware 1122 is illustrated as discrete components, this is not intended to be limiting, and any components of hardware 1122 may be combined with, or leveraged by, any other components of hardware 1122.

In at least one embodiment, AI system(s) 1224 may include a purpose-built computing system (e.g., a super-computer or an HPC) configured for inferencing, deep learning, machine learning, and/or other artificial intelligence tasks. In at least one embodiment, AI system(s) 1224 (e.g., NVIDIA's DGX™) may include GPU-optimized software (e.g., a software stack) that may be executed using a plurality of GPUs/graphics 1222, in addition to CPUs, RAM, storage, and/or other components, features, or functionality. In at least one embodiment, one or more AI system(s)s 1224 may be implemented in cloud 1226 (e.g., in a data center) for performing some or all of AI-based processing tasks of system 1200.

In at least one embodiment, cloud 1226 may include a GPU-accelerated infrastructure (e.g., NVIDIA's NGC™) that may provide a GPU-optimized platform for executing processing tasks of system 1200. In at least one embodiment, cloud 1226 may include an AI system(s) 1224 for performing one or more of AI-based tasks of system 1200 (e.g., as a hardware abstraction and scaling platform). In at least one embodiment, cloud 1226 may integrate with application orchestration system 1228 leveraging multiple GPUs to enable seamless scaling and load balancing between and among applications and services 1120. In at least one embodiment, cloud 1226 may be tasked with executing at least some of services 1120 of system 1200, including compute service(s) 1216, AI service(s) 1218, and/or visualization service(s) 1220, as described herein. In at least one embodiment, cloud 1226 may perform small and large batch inference (e.g., executing NVIDIA's TensorRT™), provide an accelerated parallel computing platform 1230 (e.g., NVIDIA's CUDA®), execute application orchestration system 1228 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1200. In at least one embodiment, parallel computing platform 1230 may include an API.

In at least one embodiment, in an effort to preserve patient confidentiality (e.g., where patient data or records are to be used off-premises), cloud 1226 may include a registry, such as a deep learning container registry. In at least one embodiment, a registry may store containers for instantiations of applications that may perform pre-processing, post-processing, or other processing tasks on patient data. In at least one embodiment, cloud 1226 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
obtaining a first record lock;
generating one or more records to be consumed by one or more consumer processes;
storing the one or more records in one or more queues comprising a first index queue associated with a first consumer process of the one or more consumer processes, a counter queue, and a unified record-index queue, wherein at least a first value associated with a first record of the one or more records is stored in the first index queue, and wherein storing the one or more records comprises:
storing a counter value corresponding to a count of the one or more records in the counter queue;
storing the first record in the unified record-index queue; and
storing an index of the first record in the first index queue, wherein the index of the first record is the first value associated with the first record;
responsive to receiving a first signal from the first consumer process, freeing the first value associated with the first record from the first index queue; and
releasing the first record lock.

2. The method of claim 1, wherein storing the first record in the unified record-index queue further comprises storing, with the first record in the unified record-index queue, a counter index associated with the counter value in the counter queue.

3. The method of claim 1, further comprising, further responsive to receiving the first signal from the first consumer process, decrementing the counter value in the counter queue.

4. The method of claim 1, wherein the first record lock corresponds to the counter value in the counter queue; and wherein releasing the first record lock is performed responsive to the counter value equaling a lock release value.

5. The method of claim 1, wherein a length of the first index queue is at least double a maximum active entries value of the first index queue.

6. The method of claim 1, wherein the first consumer process is associated with a node array, and wherein a length of the first index queue is based on a maximum number of records the first consumer process can receive and a maximum number of producer processes that can execute simultaneously.

7. The method of claim 1, wherein a length of the unified record-index queue is at least double a maximum active entries value of the unified record-index queue.

8. The method of claim 1, wherein a length of the unified record-index queue is based on a sum of a maximum number of records that can be received by a subset of the one or more consumer processes and a maximum number of producer processes that can execute simultaneously.

9. The method of claim 1, wherein a length of the counter queue is based on a maximum number of producer processes that can be executing simultaneously and that are associated with the first consumer process.

10. The method of claim 1, wherein the first record comprises data that the first consumer process depends on for performing one or more operations.

11. A system comprising:
a memory storing one or more queues comprising a first index queue associated with a first consumer process, a counter queue, and a unified record-index queue; and
processing circuitry coupled to the memory, the processing circuitry to:
obtain a first record lock;
receive one or more records to be consumed by one or more consumer processes comprising the first consumer process;
store the one or more records in the one or more queues, wherein at least a first value associated with a first record of the one or more records is stored in the first index queue, wherein to store the one or more records, the processing circuitry is to:
store a counter value corresponding to a count of the one or more records in the counter queue;
store the first record in the unified record-index queue; and
store an index of the first record in the first index queue, wherein the index of the first record is the first value associated with the first record;
responsive to receiving a first signal from the first consumer process, free the first value associated with the first record from the first index queue; and
release the first record lock.

12. The system of claim 11, wherein to store the first record in the unified record-index queue, the processing circuitry is further to store, with the first record in the unified record-index queue, a counter index associated with the counter value in the counter queue.

13. The system of claim 11, wherein the processing circuitry is further to, further responsive to receiving the first signal from the first consumer process, decrement the counter value in the counter queue.

14. The system of claim 11, wherein the first record lock corresponds to the counter value in the counter queue; and wherein releasing the first record lock is performed responsive to the counter value equaling a lock release value.

15. The system of claim 11, wherein a length of the first index queue is at least double a maximum active entries value of the first index queue.

16. The system of claim 11, wherein a length of the unified record-index queue is at least double a maximum active entries value of the unified record-index queue.

17. The system of claim 11, wherein the first record comprises data that the first consumer process depends on for performing one or more operations.

18. A system comprising:
a first processor;
a second processor to generate one or more records to be accessed by the first processor; and
processing circuitry coupled to the first processor and the second processor, the processing circuitry to:
obtain a first record lock;
store the one or more records in one or more queues comprising a first index queue associated with a first consumer process executed by the first processor, a counter queue, and a unified record-index queue, wherein at least a first value associated with a first record of the one or more records is stored in the first index queue, and wherein to store the one or more records, the processing circuitry is to:
store a counter value corresponding to a count of the one or more records in the counter queue;
store the first record in the unified record-index queue; and
store an index of the first record in the first index queue, wherein the index of the first record is the first value associated with the first record;
responsive to receiving a first signal from the first consumer process, free the first value associated with the first record from the first index queue; and
release the first record lock.

19. The system of claim 18, wherein to store the first record in the unified record-index queue, the processing circuitry is further to store, with the first record in the unified record-index queue, a counter index associated with the counter value in the counter queue.

20. The system of claim 18, wherein the processing circuitry is further to, further responsive to receiving the first signal from the first consumer process, decrement the counter value in the counter queue.

21. The system of claim 18, wherein the first record lock corresponds to the counter value in the counter queue; and wherein releasing the first record lock is performed responsive to the counter value equaling a lock release value.

22. The system of claim 18, wherein a length of the first index queue is at least double a maximum active entries value of the first index queue.

23. The system of claim 18, wherein a length of the unified record-index queue is at least double a maximum active entries value of the unified record-index queue.
